(19) United States
(12) Patent Application Publication
(10) Pub. No.: US 2002/0023048 A1
(43) Pub. Date: Feb. 21, 2002

(54) Securities trading system with latency check

(76) Inventors: Philippe Buhannic, New York, NY (US); Joseph Ahearn, New York, NY (US)

Correspondence Address: NIXON PEABODY, LLP, 8180 GREENSBORO DRIVE, SUITE 800, MCLEAN, VA, 22102, US

(21) Appl. No.: 09/891,218

(22) Filed: Jun. 26, 2001

Related U.S. Application Data
(60) Provisional application No. 60/214,256, filed on Jun. 26, 2000.
(60) Provisional application No. 60/298,083, filed on Jun. 15, 2001.

(51) Int. Cl. G06F 17/60

(52) U.S. Cl. 705/37

(57) ABSTRACT

A securitas trading system including a node for facilitating transactions, at least one buy side computer associated with a party desiring to purchase, at least one sell side computer associated with a party desiring to sell and a communication channel coupling the node with the buy side computer and the sell side computer. The latency of the communications channel is determined in real time and parameters of a trade can be adjusted based on the latency and predetermined logic elements.

### RELATED APPLICATION DATA

This application claims benefit of provisional patent applications Ser. No. 60/214,256 filed on Jun. 26, 2000 and Ser. No. 60/298,083 filed on Jun. 15, 2001, the disclosures of which are hereby incorporated herein by reference.

### BACKGROUND

The invention relates generally to automated trading of securities and more particularly to a method and apparatus for checking the latency of components in an electronic trading environment and adjusting trade parameters based on the latency.

The global financial marketplace represents the single largest purchasing market in the world. Historically, trading was conducted by placing a telephone call to a “broker” who would place an order with a national or regional exchange, in the case of listed products, or in the case of nonlisted or over the counter (“OTC”) products, with a specialty firm that makes a marker for the product. When an order was placed at an exchange, “traders” on the trading floor of a stock exchange effected the trade and the trades were confirmed by some form of notation or writing on paper. Once effected, the trades or transfers of the securities were formally reported back to the brokers for the purchasing and selling customers in a formal way.

More recently, securities transactions have become automated so that trades may be accomplished by a trader operating a keyboard to enter the necessary commands into a terminal or client computer coupled to a server of the applicable exchange. With an automated system a trader may enter an order to buy or sell which is transmitted to the central system of the applicable exchange where it is matched with another trader who is willing to sell or buy the same securities, and the computer then confirms the completion of the transaction to each trader, and the transaction is confirmed and recorded by means of a hard copy generated on a printer.

In recent years, the equity markets have moved to adopt electronic trading on a global scale at a much more accelerated pace than have the other financial markets through the advent of Internet-based electronic trading systems (e.g., electronic retail brokerage) and standardization of communications protocol. Electronic trading has greatly increased the speed and efficiency of markets by providing information relating to trades in real substantially real time. However, even in electronic trading, delay in communications, such as when a particular communication channel and/or device (collectively referred to as “links” herein) is overloaded or not working properly, can greatly affect the result of the trade and thus the profits (and loss) of the investor. It is known generally to test latency of communications links, i.e., the period of time that it takes a data packet to travel from a source to a destination. However, known latency detection systems merely produce a batch report. However, because trading of securities is very temporal, i.e., many factors change quickly over time, execution time of trades and other transactions is critical. Accordingly, conventional latency checking systems merely indicate that a problem existed but do not facilitate changing trading parameters to avoid problems.

### SUMMARY OF THE INVENTION

An object of the invention is to facilitate electronic trading of equities. To achieve this and other objects, an aspect of the invention is a computer architecture for effecting equities trades comprising a node, at least one buy side computer associated with a party desiring to purchase equities and capable of transmitting messages related to a trade, at least one sell side computer associated with a party desiring to sell securities and capable of transmitting messages related to a trade, and a communication channel coupling said node with said buy side computer and said sell side computer. The architecture further includes means for determining the latency of the communications channel and means for adjusting parameters of the trade based on the latency.

### BRIEF DESCRIPTION OF THE DRAWING

The invention will be described through a preferred embodiment and the attached drawing in which:

FIG. 1 is a schematic illustration of a computer architecture for a trading system in accordance with the preferred embodiment; and

FIG. 2 is a table of latency information displayed by the preferred embodiment.

### DETAILED DESCRIPTION

Large buy-side institutional investors increasingly are demanding increased efficiencies similar to the automated retial equity market in terms of market access and liquidity, simplified clearing and settlement capability, and more direct, transparent access to information to facilitate the trading process. Specifically, these investors seek a “customer-oriented,” as opposed to “product- or dealer-oriented,” system. Applicant has identified capabilities that would increase market access and liquidity and provide better access to information in the trading process for such institutional investors and other parties. By detecting latency in the trading environment and displaying latency information in real time, the trading process can be adjusted to avoid errors due to latency and maximize efficiency of the trading process.

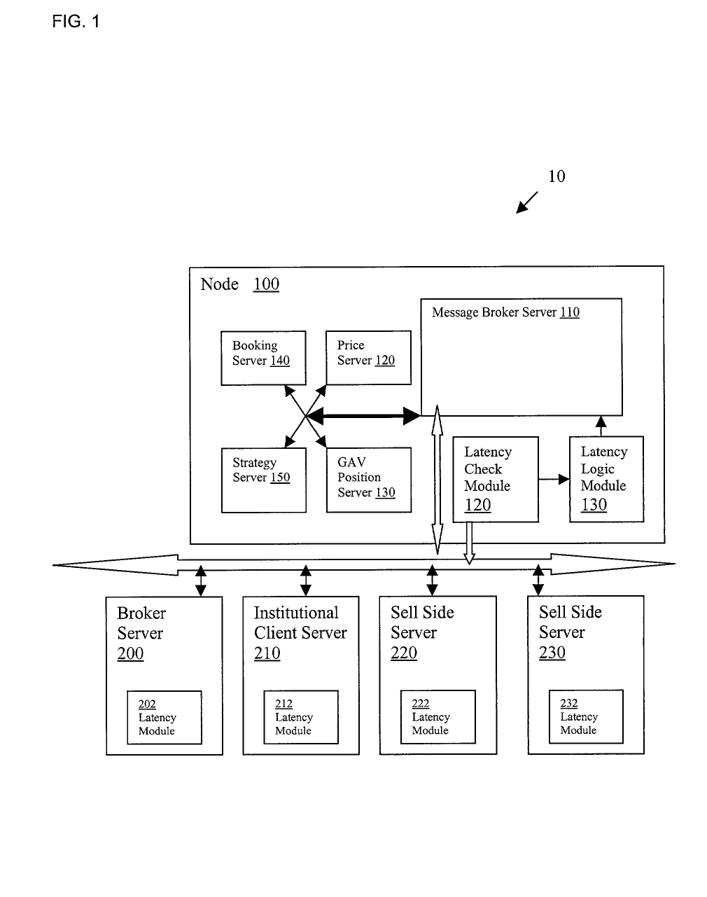

FIG. 1 is a block diagram of a trade state processing system in accordance with a preferred embodiment of the invention. System 10 includes node 100, as described in detail below. There may be a plurality of similar nodes in a clustered arrangement, redundant mirror arrangement, or coupled in any manner to provide scalability and/or fail-safe operation. Node 100 includes message broker server 110 which is Java Message Service (JMS) compliant and capable of transmitting and receiving messages in extensible Markup Language (XML). Mapping can be used to interface node 100 with devices providing any type of messaging. Message broker server 110 interacts with other servers in system 10 through messaging to exchange information about securities transactions.

Node 100 also includes product and price server 120 for obtaining and storing prices and market depth, in real time, for a plurality of products. Such products can include foreign and U.S. equities, foreign equities, equities options, futures, foreign exchange, government bonds, money markets, corporate and Euro bonds, swaps, repos, commodities and esoteric OTC products. Strategy server 150 stores trading strategy profiles for various buy side clients, such as individual investors or institutional investors, and includes the appropriate logic to initiate execution of a trade for a buy side client when the conditions or limits in the client's strategy profile are satisfied or met. Gross Asset Value (GAV) position server 130 for aggregating the portfolio of each investor, including securities and case, and for determining the gross asset value of each portfolio on a real time basis. Booking server 140 effects all transactions upon notice from strategy server 150 or a message received through message broker server 110. Node 100 also includes latency check module 120 and latency logic module 130 discussed in greater detail below.

Node 100 is coupled to broker server 220 (as a buy side server), institutional investor server 210 (as a buy side server), and sell side servers 230 and 240. Broker server 220 is associated with a securities broker, i.e., a firm or person engaged in executing orders to buy or sell securities for customers. Institutional investor server 210 is associated with an institutional investor, i.e. a firm or person engaged in managing and investing securities for others through a vehicle such as a mutual fund, retirement plan, or the like. Sell side servers 230 and 240 are associated with an exchange, such as a stock exchange, futures exchange, or the like. Each server respectively automates the processes of the associated entity and includes status information for transactions within the respective entity. For example, each server can be a conventional ECN or ATS. Further, each server is coupled to the node through a communication channel, such as the Internet, a LAN or a WAN, and the requisite cabling, wireless links, or the like.

Broker server 200 includes latency module 202, institutional client server 210 includes latency module 212, sell side server 220 includes latency module 222, and sell side server 230 includes latency module 232. In the preferred embodiment, latency modules 202, 212, 222, and 232 are in the form of Java servlets downloaded by latency module 120. However, the latency modules can be any software and/or hardware for accomplishing the functionality described below.

Latency check module 120 establishes communication with each of servers 100, 210, 220, and 230, through the respective latency modules 202, 212, 222, and 232, to continuously check latency of system 10 in general and each server in particular. For example, Packet Internet Groper (PING) technology can be used to send a packet of data between the appropriate servers and logic in latency check module 120 can measure the time required for a reply from the appropriate latency module.

Latency data can be communicated to users on a continuous basis. For example, the communication channels between servers and the servers themselves can be presented graphically on a display with a visual indication of the connectivity state. In the preferred embodiment, a “stop light” paradigm is used for each link. Thresholds of latency times are set in latency logic module 130 to display one of a red (no connectivity), green (good connectivity), or yellow (poor connectivity) color depending on the latency of the link as discussed below.

Communication between latency check module 120 and latency modules 202, 212, 222, and 232, and corresponding messaging information sent between servers and coordinated by message broker server 110, the latency of each network segment or link, the latency of each server, the volume of users and trades across various markets, and the general connectivity of all parties can be presented to each party through either a GUI (graphical user interface) or the system API (application programming interface).

As noted above, trading variables are very temporal and loss of a few seconds can have drastic, and sometimes disastrous, consequences on the trade. Therefore, merely knowing about latency problems in real time is not always sufficient. Accordingly, trading alerts and other logic elements can be programmed into latency check module 130. In the preferred embodiment, latency logic module 130 is centralized, i.e., located in node 100. However, a latency logic module 130 can be located in each server or device and each can contain programmed logic elements for the appropriate party based on the particular trading needs of the party. For example, if a trader is trading futures through the broker associated with broker server 200 on sell side server 220 associated with an exchange, a logic element in latency logic module 130 may be programmed to only send orders when Broker server 200 is connected with a latency of 100 milliseconds or less and sell side server 220 is connected with a latency of 50 milliseconds or less. If these conditions are not met, a warning message and prompt to cancel or continue the trade can be displayed to the trader or other authorized party.

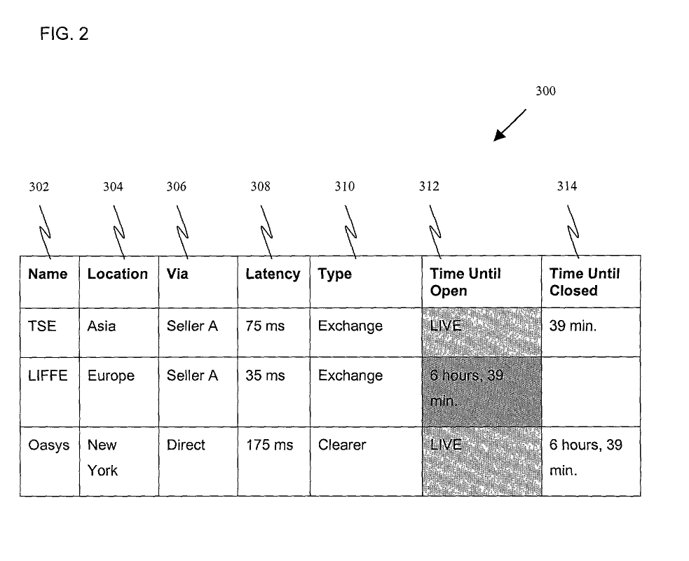

FIG. 2 illustrates latency chart 300 of the preferred embodiment which can be displayed on a display device of any computer coupled to the system and authorized to view latency information. Column 302 designates the name of the external linkage, e.g., the server associated with a buy side party or a sell side party. Column 304 designates the geographic region of the external linkage. Column 306 indicates whether the linkage is direct from the system of through a counter party. Column 308 indicates the latency time for the linkage based on the tests described above. Column 310 indicates the type of party associated with the linkage, such as an exchange, a clearer, an allocation system, and the like. Column 312 indicates whether the party associated with the link is open and indicates “open” with green highliting (light gray in FIG. 2) and “closed” with red highliting (dark gray in FIG. 2). When closed, the time until opening of the linkage is displayed. Column 314 is empty if the linkage is closed, and show the time until the linkage closes when the linkage is open. The user interface can permit selection of a row corresponding to a linkage, by a right mouse click for example, to permit entry of logic elements into latency logic module 130. As described above, an open linkage with a latency over a predetermined value can be displayed in yellow in column 312.

The system of the preferred embodiment provides a total view of the health of the securities trading platform. Further, trading decisions can be made, manually or automatically, based on the latency of a linkage. Therefore, losses and inefficiencies due to latency can be minimized or avoided entirely.

The various servers and modules are broken down in the preferred embodiment by specific functions for the purpose of explaining the invention. However, these elements can be segregated and/or combined. For example, latency logic module 130 can be associated with plural servers or nodes. Further, the various server functions can be combined in a single device or multiple devices and can be embodied in hardware and/or software. Accordingly, the term “server” as used herein does not refer to a specific or distinct piece of hardware and may include one or more computers or other devices, or may be embodied in software residing in a single computer or device. Any type of communication channels can be used for transmitting the various messages. For example, the messages can be transmitted over the Internet using a secured sockets layer (SSL) or a private leased line can be used. The messages and records can be in any format. Any party to a trade, or other party requiring information with respect to a trade can be coupled to the system. The various logic elements and other programming can be accomplished through any known language or protocol. Any parameters of a trade can be adjusted by the logic elements. For example, the trade can be rerouted, cancelled, or otherwise changed if latency is not within a desired range. The invention can be applied to any type of securities trade.

The invention has been described through a preferred embodiment. However, various modifications can be made without departing from the scope of the invention as defined by the appended claims and legal equivalents.

What is claimed:

1. A computer architecture for effecting securities trades, said architecture comprising:
a node;
at least one buy side computer associated with a party desiring to purchase securities and capable of transmitting messages related to a trade;
at least one sell side computer associated with a party desiring to sell securities and capable of transmitting messages related to a trade; and
a communication channel coupling said node with said buy side computer and said sell side computer;
means for determining the latency of said communications channel; and
means for adjusting parameters of the trade based on the latency.

2. An architecture as recited in claim 1, wherein said at least one buy side computer comprises a server associated with a securities broker.

3. An architecture as recited in claim 1, wherein said at least one buy side computer comprises a server associated with an institutional investor.

4. An architecture as recited in claim 1, wherein said at least one sell side computer comprises a server associated with an exchange.

5. An architecture as recited in claim 1, wherein said means for adjusting comprises predetermined logic elements and means for applying the logic elements to an equities transaction.
